(19) United States
(12) Patent Application Publication
(10) Pub. No.: US 2026/0003584 A1
(43) Pub. Date: Jan. 1, 2026

(54) SYSTEM AND METHOD FOR OBSERVABILITY AND DATA AUDIT USING IMPLICIT DATA DEPENDENCY CAPTURE

(71) Applicant: Hugging Face, Inc., Brooklyn, NY (US)

(72) Inventor: Yucheng LOW, Seattle, WA (US)

(21) Appl. No.: 19/250,955

(22) Filed: Jun. 26, 2025

Related U.S. Application Data
(60) Provisional application No. 63/666,023, filed on Jun. 28, 2024.

(51) Int. Cl. G06F 8/35; G06N 20/00

(52) U.S. Cl. CPC G06F 8/35; G06N 20/00

(57) ABSTRACT

The disclosure is directed to systems, methods, and computer-readable media for observability and data audit using implicit data dependency capture. Data dependency information can be intercepted, for example, as a user trains or otherwise interacts with a machine learning (ML) model. Data dependency information can include information regarding files, data sources, inputs, outputs, storage buckets, storage directories, and/or other pertinent information. A log of the data dependency information can be reviewed to determine ML model provenance.

### PRIORITY INFORMATION

The present application claims the benefit of U.S. Patent Provisional Application No. 63/666,023, filed Jun. 28, 2024, the content of which is incorporated herein by reference in its entirety.

### FIELD OF THE INVENTION

The present disclosure relates to an implicit dependency tracking tool that observes, when training a machine learning model or using the machine learning model for inference, actions associated with data used to train or use the machine learning model. The actions are performed by a training command run to train or use the machine learning model. The tool generates a database or log including the data and determines, based on the data, the machine learning model's provenance without altering the source code associated with executing components of the machine learning model.

### BACKGROUND

Provenance is a challenging problem for certain high-assurance industries, such as finance, insurance, biotech, and so forth. Provenance generally refers to knowledge about the origin or source of something, or the history of ownership and transmission of an object such as a document or data. When Machine Learning (ML) methods are used in such industries, it can be useful to know exactly what data contributed to the creation of the ML model. For instance, for fraud models, it can be useful to audit that information about protected classes does not leak into the model. In Contract Research Organizations (CROs), it can be useful to ensure that analyses performed for a given client do not accidentally make use of information from other clients.

Existing solutions to data provenance require explicit dependency tracking, requiring users to define dependencies upfront. Consider a “Makefile”. A Makefile is a special file used by a “make build automation” tool to control how a program is compiled and built. It's commonly used in C, C++, and other compiled languages, but can be used for automating any kind of task. In this example, one can declare that the output file “main.o” depends on two input files “main.c” and “defs.h”, and is produced by running the command “cc-c main.c”. The code can be as follows:
Main.o: main.c defs.h
   cc-c main.c

The “make” tool is an automation tool that builds software projects by tracking dependencies and executing commands defined in the Makefile, making compilation and other tasks efficient and repeatable.

Another tool relates to DVC (Data Version Control) pipelines. A DVC pipeline refers to a data pipeline defined and managed using DVC-a tool that helps with versioning data, models, and pipelines in machine learning and data science projects. The DVC pipeline involves the user explicitly creating a stage named “featurize”, which takes two inputs “src/featurization.py” and “data/prepared”, outputs into “data/features” and runs the python command. Example code is as follows:

```
$ dvc stage add -n featurize \
  -p featurize.max_features, featurize.ngrams \
  -d src/featurization.py -d data/prepared \
  -o data/features \
  python src/featurization.py data/prepared data/features
```

Explicit dependency tracking can be annoying, fragile, inflexible, and unnatural to use. The user is forced to centralize on one tool, which is not necessarily the best or right thing, just to get observability and provenance.

### SUMMARY

The approach described above, which describes explicit dependency tracking, involves preparing the data, featurizing the data, and then training the model. Such code is very fragile and complex to use, as the user is not able to use the most convenient methods to access data, and the user may accidentally forget to include certain essential dependencies. The approach makes provenance about data associated with an ML model difficult to obtain and utilize. What is needed is a new general solution to the provenance problem. That is, for a given artifact (ML model, data visualization, business decision), it is desirable to know precisely what data contributed to its creation.

Data provenance tools and libraries exist for ML. However, using these tools will require ML scientists to redesign their training code to use them and make significant workflow changes. Human developers will also have to carefully define the required data dependencies up front for each model training job. This is inconvenient, error-prone, and extremely fragile. Small errors will cause job failures, which can be difficult to diagnose and debug.

For data processing, visualization, and other domains where provenance is also important, such tools do not exist, and a custom solution will have to be built. Such custom solutions will also not integrate well with existing ML data provenance tools resulting in scattered solutions which do not work together. Disclosed herein are methods, systems, and computer-readable media for implicit dependency tracking. In some aspects, a platform can include one or more executables programmed to intercept and observe user actions (e.g., when training or using a machine learning model). The platform can then generate a database (e.g., a log) that can include data such as file read information (file names, versions, and so forth), source bucket or directory information (path, git repo identifiers and/or commit version, and so forth), output file information, or other suitable information. The creation or generation of the log enables the user to determine data and/or ML model provenance without the need to alter source code associated with executing model components. The data can, for instance, be obtained directly from an S3 bucket in src/featurization.py. An S3 object is the fundamental unit of data storage in Amazon S3 (Simple Storage Service), which is Amazon Web Services' (AWS) cloud-based storage service. The reference to an S3 object is by way of example only as other data storage mechanisms can be used as well.

In some aspects, the techniques described herein relate to a method including: observing, when training a machine learning model and via a software tool, actions associated with data used to train the machine learning model, wherein the actions are performed by a training command run to train the machine learning model; generating a database including the data; and determining, based on the data, machine learning model provenance without altering source code associated with executing components of the machine learning model. The system can observe the inputs used, the outputs created—which are captured in the database or log—without modifying the project code or the command used to train the model.

In some aspects, the techniques described herein relate to a system including: one or more processor; and a computer-readable storage device storing instructions which, when executed by the one or more processor, cause the one or more processor to be configured to: observe, when training a machine learning model and via a software tool, actions associated with data used to train the machine learning model, wherein the actions are performed by a training command run to train the machine learning model; generate a database including the data; and determine, based on the data, machine learning model provenance without altering source code associated with executing components of the machine learning model.

In some aspects, the techniques described herein relate to a computer-readable storage device storing instructions which, when executed by one or more processor, cause the one or more processor to be configured to: observe, when training a machine learning model and via a software tool, actions associated with data used to train the machine learning model, wherein the actions are performed by a training command run to train the machine learning model; generate a database including the data; and determine, based on the data, machine learning model provenance without altering source code associated with executing components of the machine learning model.

In some aspects, the techniques described herein relate to a software tool for use in connection with implementing operations associated with a companion command, wherein the software tool, when implemented, causes one or more processor to be configured to: observe, when training a machine learning model, actions associated with data used to train the machine learning model, wherein the actions are performed by a training command run to train the machine learning model; generate a database including the data; and determine, based on the data, machine learning model provenance without altering source code associated with executing components of the machine learning model.

Another example aspect relates to the use of the software tool when running a machine learning model for inference. During inference (i.e., invoking a trained ML model to provide a prediction based on supplied input), the approach enables having the same observability solution described for training the ML model and that allows for provenance-tracking of predictions to the inputs.

Complex ML models often rely on additional information not captured in the ML model file itself, so applying a system like this allows for understanding how the model determined its prediction.

In some aspects, a method includes: observing, when operating a machine learning model and via a software tool, actions associated with data used to use the machine learning model, wherein the actions are performed by a command run to use the machine learning model; generating a database comprising the data; and determining, based on the data, machine learning model provenance without altering source code associated with executing components of the machine learning model.

In some aspects, a system includes: one or more processor; and a computer-readable storage device storing instructions which, when executed by the one or more processor, cause the one or more processor to be configured to: observe, when operating a machine learning model and via a software tool, actions associated with data used to use the machine learning model, wherein the actions are performed by a command run to use the machine learning model; generate a database comprising the data; and determine, based on the data, machine learning model provenance without altering source code associated with executing components of the machine learning model.

In some aspects, a computer-readable storage device stores instructions which, when executed by one or more processor, cause the one or more processor to be configured to: observe, when operating a machine learning model and via a software tool, actions associated with data used to use the machine learning model, wherein the actions are performed by a command run to use the machine learning model; generate a database comprising the data; and determine, based on the data, machine learning model provenance without altering source code associated with executing components of the machine learning model.

In some aspects, a software tool can be configured to: observe, when operating a machine learning model, actions associated with data used to use the machine learning model, wherein the actions are performed by a command run to use the machine learning model; generate a database comprising the data; and determine, based on the data, machine learning model provenance without altering source code associated with executing components of the machine learning model.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram showing some of the components typically incorporated in at least some of the computer systems and other devices on which the disclosed system operates in accordance with some implementations of the present technology.

FIG. 2 is a system diagram illustrating an example of a computing environment in which the disclosed system operates in some implementations of the present technology.

FIG. 3 illustrates example data obtained from using the tool, in accordance with some implementations of the present technology.

FIG. 4 illustrates example data obtained from using the tool for remotely accessing data or for accessing data in a cloud environment, in accordance with some implementations of the present technology.

FIG. 5 is a block diagram illustrating a method embodiment, in accordance with some implementations of the present technology.

The drawings have not necessarily been drawn to scale. For example, some components and/or operations may be separated into different blocks or combined into a single block for the purposes of discussion of some of the embodiments of the disclosed system. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents and alternatives falling within the scope of the technology as defined by the appended claims.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Disclosed herein are methods, systems, and computer-readable media for implicit dependency tracking. For example, a platform can include one or more executables programmed to intercept and observe user actions (e.g., when training a machine learning model). The platform can then generate a database (e.g., a log) that can include file read information (file names, versions, and so forth), source bucket or directory information (path, git repo identifiers, commit version, and so forth), output file information, or other suitable information. This enables the user to determine data and/or ML model provenance without the need to alter source code associated with executing model components. The data can, for instance, be obtained directly from an S3 bucket in src/featurization.py.

The disclosure introduces systems, methods, and computer-readable media for observability and data audit using implicit data dependency capture. Data dependency information can be intercepted, for example, as a user trains or otherwise interacts with a machine learning (ML) model. The approach can be applied during training or during inference in connection with an ML model. Data dependency information can include information regarding files, data sources, inputs, outputs, storage buckets, storage directories, and/or other pertinent information.

The innovation relates to implicit dependency tracking, in which the user runs an additional command in addition to the command to train their model. The command to trace all dependencies can, for example, be: “xetrace python code/main.pv.” The “xetrace” tool can observe all the actions performed by the user's command, and produce a complete log of: every file the command reads, every file in any git repos and the version accessed, every S3 object accessed, the date and version and every output file created. The approach allows the user to achieve data and model provenance with no code changes. This process is resilient and works with all workflows, and requires no user intervention.

The approach can be extended to support any other storage system. For example, the tool can identify reads and writes to Google Cloud Platform, Microsoft Azure Blob Store, etc. The tool can also identify reads from databases, data warehouses and data lakes. After training a model, the user can now easily explore the log file to verify that all data accesses come from allowed data sources, and quickly identify data leakages, with the confidence that nothing was missed.

Further, reference to machine learning models generally refers to any type of model and can include, without limitation, artificial neural networks (ANNs), convolutional neural networks (CNNs), recurrent neural networks (RNNs)/LSTM/GRU, transformers, reinforcement learning algorithms, Q-learning models, and deep Q-networks (DQN). Those skilled in the art will understand these various types of machine learning models or artificial intelligence models. The principles disclosed herein can apply to any such models.

The tool works to intercept all file accesses at the operating system level, thus ensuring that all local accesses are tracked reliably. For remote data access, such as S3 and other databases, the tool works by acting as an HTTP proxy, intercepting all network communication performed by the user's command.

The new tool achieves robust, easy, and reliable dependency tracking and data provenance, allowing organizations to have confidence that their private data is used responsibly.

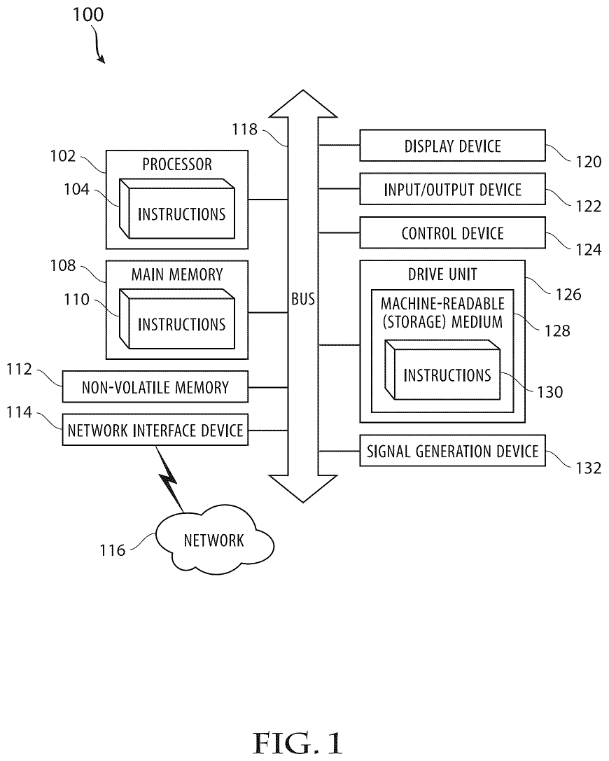

FIG. 1 is a block diagram showing some of the components typically incorporated in at least some of the computer systems and other devices, such as a computer system 100 on which the disclosed system operates in accordance with some implementations of the present technology. As shown, the computer system 100 can include: one or more processor 102, a main memory 108, a non-volatile memory 110, a network interface device 114, a video display device 120, an input/output device 122, a control device 124 (e.g., keyboard and pointing device), a drive unit 126 that includes a machine-readable medium 128, and a signal generation device 132 that are communicatively connected to a bus 118. The bus 118 represents one or more physical buses and/or point-to-point connections that are connected by appropriate bridges, adapters, or controllers. Various common components (e.g., cache memory) are omitted from FIG. 1 for brevity. Instead, the computer system 100 is intended to illustrate a hardware device on which components illustrated or described relative to the examples of the figures and any other components described in this specification can be implemented.

The computer system 100 can take any suitable physical form. For example, the computer system 100 can share a similar architecture to that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 100. In some implementations, the computer system 100 can be an embedded computer system, a system-on-chip (SOC), a single-board computer system (SBC), or a distributed system such as a mesh of computer systems, or include one or more cloud components in one or more networks. Where appropriate, one or more computer systems can perform operations in real-time, near real-time, or in batch mode.

The network interface device 114 enables the computer system 100 to exchange data in a network 116 with an entity that is external to the computing system 100 through any communication protocol supported by the computer system 100 and the external entity. Examples of the network interface device 114 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., the main memory 108, the non-volatile memory 112, the machine-readable medium 128) can be local, remote, or distributed. Although shown as a single medium, the machine-readable medium 128 can include multiple media (e.g., a centralized/distributed database and/or associated caches and servers) that store one or more sets of instructions 130. The machine-readable medium 128 can include any medium that is capable of storing, encoding, or carrying a set of instructions for execution by the computer system 100. The machine-readable medium 128 can be non-transitory or can be a non-transitory machine-readable storage device. In this context, a non-transitory storage medium can include a device that is tangible, meaning that the device has a concrete physical form, although the device can change its physical state. Thus, for example, non-transitory refers to a device remaining tangible despite this change in state. A non-transitory memory excludes the air interface which can store transitory electromagnetic signals which can represent data.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory, removable memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., stored in the non-volatile memory 110, or one or more sets of instructions 130) set at various times in various memory and storage devices in computing device(s). When read and executed by the one or more processor 102, the instruction(s) cause the computer system 100 to perform operations to execute elements involving the various aspects of the disclosure.

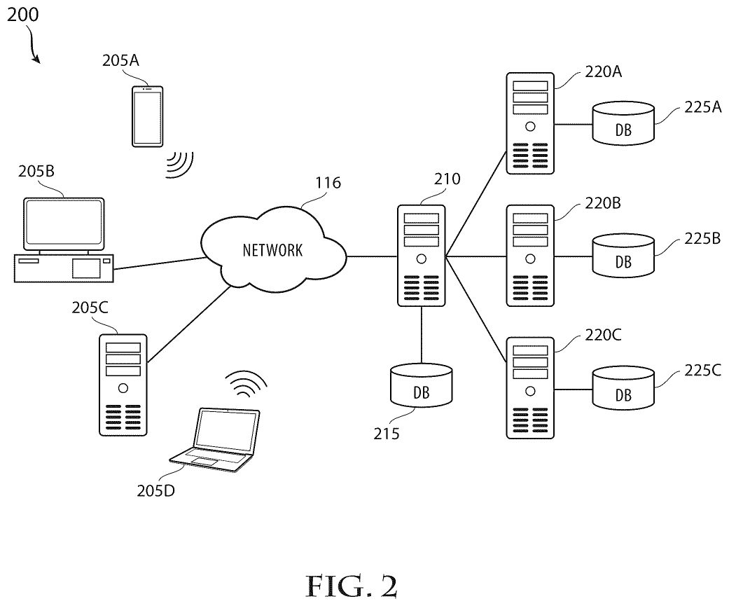

FIG. 2 is a system diagram illustrating an example of a computing environment 200 in which the disclosed system operates in some implementations. In some implementations, the computing environment 200 includes one or more client computing devices 205A-D, examples of which can host the computing system 100. The one or more client computing devices 205A-D operate in a networked environment using logical connections through the network 116 to one or more remote computers, such as a server computing device.

In some implementations, a server 210 can be an edge server that receives client requests and coordinates fulfillment of those requests through other servers, such as servers 220A-C. In some implementations, the server 210 and the servers 220A-C can include computing systems, such as the computing system 100. Though the server 210 and the servers 220A-C are displayed logically as a respective single server, server computing devices can each be a distributed computing environment encompassing multiple computing devices located at the same or at geographically disparate physical locations. In some implementations, each server of the servers 220A-C 220 corresponds to a group of servers. The server 210 or the servers 220A-C can also represent virtual devices or virtual compute resources.

The one or more client computing devices 205A-D, the server 210 and the servers 220A-C can each act as a server or client to other server or client devices. In some implementations, the server 210 and the servers 220A-C connect to a database 215 or databases 225A-C. As discussed above, each server of the servers 220A-C can correspond to a group of servers, and each of these servers can share a database or can have its own database. The database 215 and the databases 225A-C can warehouse (e.g., store) information. The database 215 and the databases 225A-C can be used to generate logs or databases of actions taken through the use of the ML model either for training or inference. Though the database 215 and the databases 225A-C are displayed logically as single units, the database 215 and the databases 225A-C can each be a distributed computing environment encompassing multiple computing devices, can be located within their corresponding server, or can be located at the same or at geographically disparate physical locations.

The network 116 can be a local area network (LAN) or a wide area network (WAN), but can also be other wired or wireless networks. In some implementations, network 116 is the Internet or some other public or private network. The one or more client computing devices 205A-D are generally connected to network 116 through a network interface, such as by wired or wireless communication. While the connections between the server 210 and servers 220A-C are shown as separate connections, these connections can be any kind of local, wide area, wired, or wireless network, including the network 116 or a separate public or private network.

In general, the approach disclosed herein relates to a new tool such as an implicit dependency tracking tool that operates, in one aspect, at an operating system level for local accesses. For example, in a command line, the tool (e.g., implemented by a command like “xetrace”) can be run in connection with a command to train an ML model. The tool will then observe all the actions performed by the user's command, and produce a complete log of one or more of (1) every file the command reads; (2) every file in any git repos and the version accessed; (3) every S3 object accessed, the date and version; and (4) every output files created. This generally describes the data that is obtained or observed by the tool in connection with the training of an ML model.

The approach allows the user to achieve data and model provenance with no code changes. The process is resilient and works with all workflows and requires no user intervention. The approach can be extended to support any other storage system. For example, the tool can identify reads and writes to Google Cloud Platform, Microsoft Azure Blob Store, etc. The tool can identify reads from databases such as the database 215, data warehouses and data lakes. After training the ML model, the user can now easily go through and explore the log file to verify that all data accessed comes from allowed data sources, and quickly identify data leakages, with the confidence that nothing was missed.

The trace process tool works by intercepting all file accesses at an operating system level, thus ensuring that all local accesses are tracked reliably. For remote data accesses such as S3 cloud-based storage service) and other databases, the tool can work by acting as a HTTP proxy, intercepting all network communication performed by the user's command.

Thus, the tool can be run on any of the one or more client computing devices 205A-D, the server 110 or the servers 220A-C. Then, the tool will operate based on whether it is tracing actions locally, remotely, or a combination of local and remote data access.

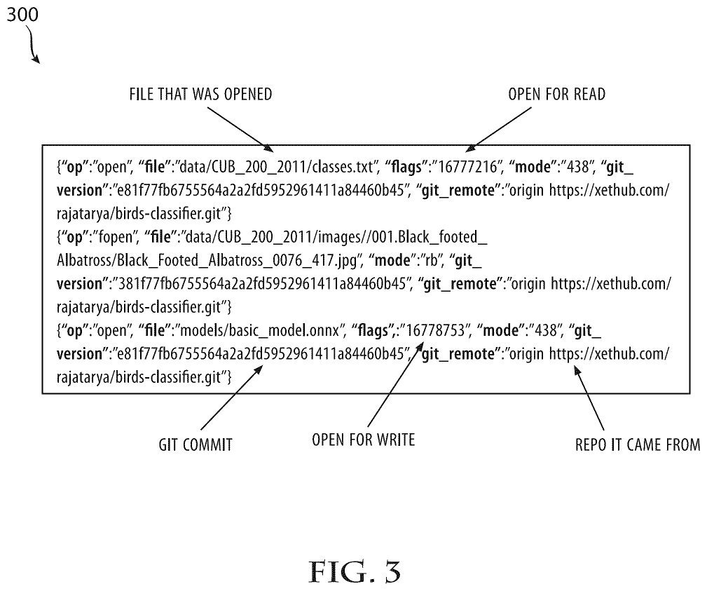

FIG. 3 illustrates an example set of data 300 that can be obtained from running the tool. For example, the traced data can include text such as: “op”: “open”, “fil”: “data/CUB_200_2011/classes.txt”. Such text can identify a file that was opened. Other data can include “flags”: “16777216, “mode”: “438”. This data can identify a file open for reading or a project code open for reading. Additional data can be: “op”: “open”, “fil”: “models/basic_model.onnx”, “flags: “16778753”, “mode”: “438”, “git version”: “e81f77fb6755564a2a2fd5952961411a84460b45”. Such data can relate to a git commit. The flag “16778753” can identify an open for write file. Further data can be: “git_remote”: “origin https://xethub.com/rajatarya/birds-classifie.git”. This data can relate to a repository a file or project code came from in the trace. FIG. 3 illustrates other data within the example set of data 300 that can be used to trade any aspect of the data associated with training the ML model.

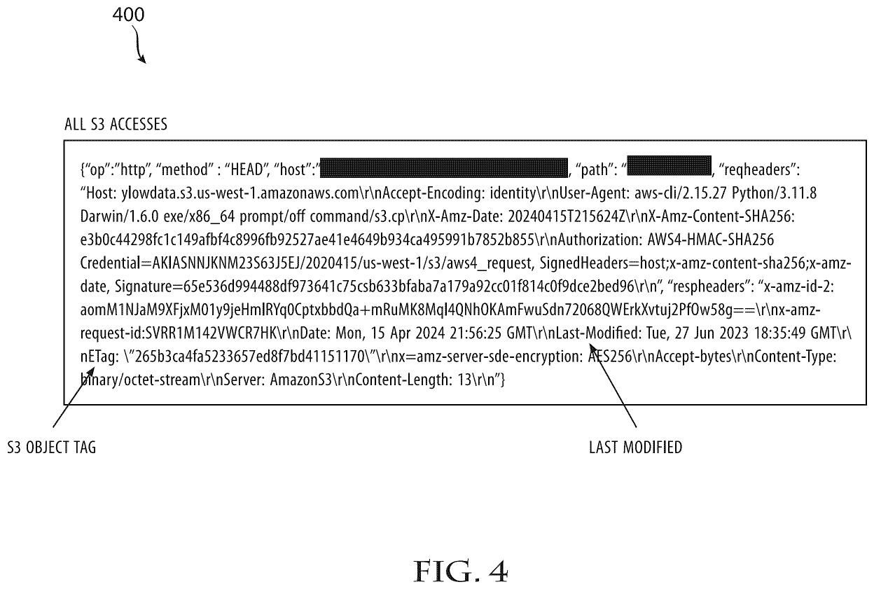

FIG. 4 illustrates example remote trace data 400 that can include such data as an identification of a host (such as Amazon or Google), a user agent, headers, signatures, modified dates, encryption data, content type, content length and so forth. For example, an S3 object tag can identify a file or other object that has some action taken in connection with the object in connecting with the training of the ML model. As noted, other data can include a last modified date and/or time.

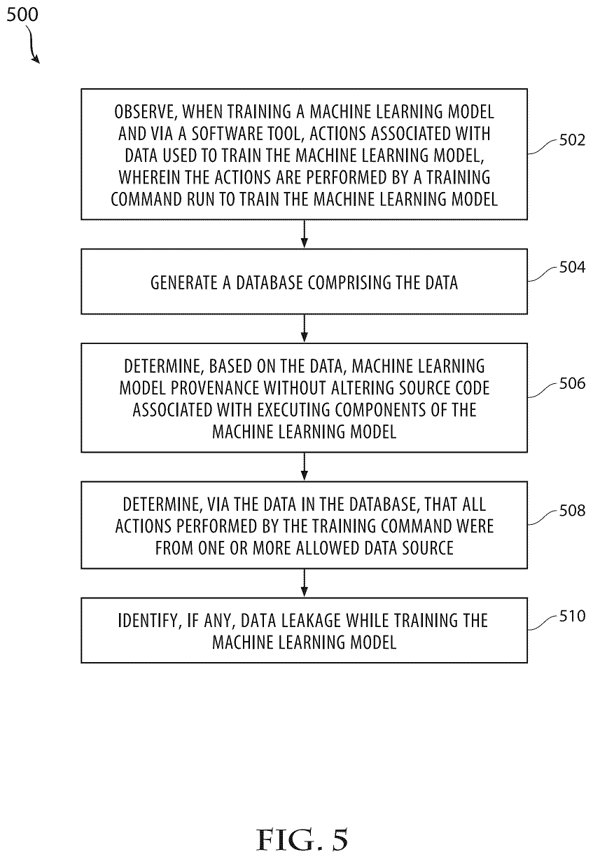

FIG. 5 illustrates a method 500 operated or implemented by a system. For example, the system be any one of the one or more client devices 205A-D, the server 210, the servers 220A-C, the computing system 100, the database 215, the databases 225A-C, the one or more processor 102, the one or more instructions 104, the main memory 108, the non-volatile memory 112, the network 116, and/or any subcomponent thereof. While the primary example disclosed below relates to a command used in connection with training an ML model, the approach equally applies to a command associated with using the ML model for inference. In other words, a software tool can also trace actions associated with inference or classification using the ML model.

At block 502, the system can and is configured to observe, when training a machine learning (ML) model and via a software tool, actions associated with data used to train the machine learning model, wherein the actions are performed by a training command run to train the machine learning model. Note that in another aspect, the system can observe, when using the ML model for inference and via a software tool, the actions associated with data used to operate the machine learning model, wherein the actions are performed by a command run to operate the ML model. A more detailed discussion of the use of the software tool during inference is provided below.

In some aspects, the data can include one or more of file read information, source bucket information, directory information or output file information. In some aspects, the file read information can include one or more of a file name, a file identifier, a file version, a date associated with a creation of a file, and a date associated with a most recent change to a file.

In some aspects, the source bucket information can include one or more of a path, a git repo identifier and commit version, a source computing device, input information, output information, and a database identification. The directory information can include one or more of a path, a git repo identifier and commit version, a source computing device, input information, output information, a directory identification and a database identification. One or more of the git repo identifier (i.e., a repo URL) and the commit version (i.e., the specific version of code repo used) can be captured.

The software tool can be, for example, an implicit dependency tracking tool that observes the actions performed by a training command (or other type of command) used to train the machine learning model. The software tool can be implemented at a command line in connection with a user command to train the ML model. Alternatively, the software tool may be automatically run or implemented via user interaction with a graphical user interface, rather than a text command-line interface.

In some aspects, the actions can include one or more of reading a file, performing a git repo done on a project code, obtaining a version of the project code, accessing a cloud-stored object having a date and version, and generating an output file.

In general, the data referenced with this step relates to all the information about all the actions taken by the software tool or the implicit dependency tracking tool. The software tool or the implicit dependency tracking tool operates at an operating system level for local access. The implicit dependency tracking tool can also act as an HTTP proxy for remote data accesses to intercept network communications the training command performs.

In some aspects, implicit dependency tracking can enable a user to use whatever tool is most sensible for a job. The tool can be used for manual runs (using command line code), shell scripts, or any other implementation. In some aspects, the system can automatically discover dependencies.

At block 504, the system can and is configured to generate a database comprising the data. The database can be a log of the various actions associated with the data and the training of the ML model. This step can also include the system creating a log of the various actions associated with the data and training or performing inference using the ML model.

At block 506, the system can and is configured to determine, based on the data, machine learning model provenance without altering source code associated with executing components of the machine learning model.

At block 508, the system can and is configured to determine, based on the data, the machine learning model provenance further by being configured to determine, via the data in the database, that all actions performed by the training command were from one or more allowed data source.

At block 510, the system can and is configured to identify, if any, data leakage while training the machine learning model.

In some aspects, a system can include one or more processor; and a computer-readable storage device storing instructions which, when executed by the one or more processor, cause the one or more processor to be configured to: observe, when training a machine learning model and via a software tool, actions associated with data used to train the machine learning model, wherein the actions are performed by a training command run to train the machine learning model; generate a database comprising the data; and determine, based on the data, machine learning model provenance without altering source code associated with executing components of the machine learning model.

In some aspects, an embodiment of this disclosure can relate to a software tool for use in connection with implementing operations associated with a companion command. The software tool, when implemented, causes one or more processor to be configured to: observe, when training a machine learning model, actions associated with data used to train the machine learning model, wherein the actions are performed by a training command run to train the machine learning model; generate a database comprising the data; and determine, based on the data, machine learning model provenance without altering source code associated with executing components of the machine learning model.

The software tool, when executed by the one or more processor, can further cause the one or more processor to be configured to determine, based on the data, the machine learning model provenance by: determining, via the data in the database, that all actions performed by the training command were from one or more allowed data source; and identifying, if any, data leakage while training the machine learning model.

The software tool can be implemented by one of a user interaction with a graphical object or a user input via a command-line interface.

In another aspect as noted above, the software tool, method, or system can implement operations for ML model inference in contrast to training. In the context of inference, a method can include: observing, when operating a machine learning model and via a software tool, actions associated with data used to use the machine learning model, wherein the actions are performed by a command run to use the machine learning model; generating a database comprising the data; and determining, based on the data, machine learning model provenance without altering source code associated with executing components of the machine learning model.

A system for implicit dependency tracking can include: one or more processor; and a computer-readable storage device storing instructions which, when executed by the one or more processor, cause the one or more processor to be configured to: observe, when operating a machine learning model and via a software tool, actions associated with data used to use the machine learning model, wherein the actions are performed by a command run to use the machine learning model; generate a database comprising the data; and determine, based on the data, machine learning model provenance without altering source code associated with executing components of the machine learning model.

A computer-readable storage device storing instructions for implicit dependency tracking can, when executed by one or more processor, cause the one or more processor to be configured to: observe, when operating a machine learning model and via a software tool, actions associated with data used to use the machine learning model, wherein the actions are performed by a command run to use the machine learning model; generate a database comprising the data; and determine, based on the data, machine learning model provenance without altering source code associated with executing components of the machine learning model.

A software tool for implicit dependency tracking can be configured to: observe, when operating a machine learning model, actions associated with data used to use the machine learning model, wherein the actions are performed by a command run to use the machine learning model; generate a database comprising the data; and determine, based on the data, machine learning model provenance without altering source code associated with executing components of the machine learning model.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples of technology are described above for illustrative purposes, various equivalent modifications are possible within the scope of the technology, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative embodiments may employ differing values or ranges.

The teachings of the technology provided herein can be applied to other systems, not necessarily the system described above. The elements and acts of the various examples described above can be combined to provide further embodiments of the technology. Some alternative embodiments of the technology may include not only additional elements to those embodiments noted above, but also may include fewer elements.

These and other changes can be made to the technology in light of the above Detailed Description. While the above description describes certain examples of the technology and describes the best mode contemplated, no matter how detailed the above appears in text, the technology can be practiced in many ways. Details of the system may vary considerably in its specific implementation, while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112 (f) will begin with the words “means for,” but use of the term “for” in any other context is not intended to invoke treatment under 35 U.S.C. § 112 (f). Accordingly, the applicant reserves the right to pursue additional claims after filing this application to pursue such additional claim forms, in either this application or in a continuing application.

Claim clauses associated with this application include:

Clause 1. A method comprising: observing, when training a machine learning model and via a software tool, actions associated with data used to train the machine learning model, wherein the actions are performed by a training command run to train the machine learning model; generating a database comprising the data; and determining, based on the data, machine learning model provenance without altering source code associated with executing components of the machine learning model.

Clause 2. The method of clause 1, wherein the data comprises one or more of file read information, source bucket information, directory information or output file information.

Clause 3. The method of clause 2 or any previous clause, wherein the file read information comprises one or more of a file name, a file identifier, a file version, a date associated with a creation of a file, and a date associated with a most recent change to a file.

Clause 4. The method of clause 2 or any previous clause, wherein the source bucket information comprises one or more of a path, a git repo identifier and commit version, a source computing device, input information, output information, and a database identification.

Clause 5. The method of clause 2 or any previous clause, wherein directory information comprises one or more of a path, a git repo identifier and commit version, a source computing device, input information, output information, a directory identification and a database identification.

Clause 6. The method of clause 1 or any previous clause, wherein the software tool comprises an implicit dependency tracking tool that observes the actions performed by a training command used to train the machine learning model.

Clause 7. The method of clause 6 or any previous clause, wherein the actions comprise one or more of reading a file, performing a git repo done on a project code, obtaining a version of the project code, accessing a cloud-stored object having a date and version, and generating an output file.

Clause 8. The method of clause 7 or any previous clause, wherein the data comprises information about all the actions taken by the implicit dependency tracking tool.

Clause 9. The method of clause 1 or any previous clause, wherein determining, based on the data, the machine learning model provenance further comprises: determining, via the data in the database, that all actions performed by the training command were from one or more allowed data source; and identifying, if any, data leakage while training the machine learning model.

Clause 10. The method of clause 6 or any previous clause, wherein the implicit dependency tracking tool operates at an operating system level for local accesses.

Clause 11. The method of clause 6 or any previous clause, wherein the implicit dependency tracking tool acts as an HTTP proxy for remote data accesses to intercept network communications performed by the training command.

Clause 12. A system comprising: one or more processor; and a computer-readable storage device storing instructions which, when executed by the one or more processor, cause the one or more processor to be configured to: observe, when training a machine learning model and via a software tool, actions associated with data used to train the machine learning model, wherein the actions are performed by a training command run to train the machine learning model; generate a database comprising the data; and determine, based on the data, machine learning model provenance without altering source code associated with executing components of the machine learning model.

Clause 13. The system of clause 12 or any previous clause, wherein the data comprises one or more of file read information, source bucket information, directory information or output file information.

Clause 14. The system of clause 13 or any previous clause, wherein the file read information comprises one or more of a file name, a file identifier, a file version, a date associated with a creation of a file, and a date associated with a most recent change to a file.

Clause 15. The system of clause 13 or any previous clause, wherein the source bucket information comprises one or more of a path, a git repo identifier and commit version, a source computing device, input information, output information, and a database identification.

Clause 16. The system of clause 13 or any previous clause, wherein directory information comprises one or more of a path, a git repo identifier and commit version, a source computing device, input information, output information, a directory identification and a database identification.

Clause 17. The system of clause 12 or any previous clause, wherein the software tool comprises an implicit dependency tracking tool that observes the actions performed by a training command used to train the machine learning model.

Clause 18. The system of clause 17 or any previous clause, wherein the actions comprise one or more of reading a file, performing a git repo done on a project code, obtaining a version of the project code, accessing a cloud-stored object having a date and version, and generating an output file.

Clause 19. The system of clause 18 or any previous clause, wherein the data comprises information about all the actions taken by the implicit dependency tracking tool.

Clause 20. The system of clause 12 or any previous clause, wherein the instructions, when executed by the one or more processor, further cause the one or more processor to be configured to determine, based on the data, the machine learning model provenance by: determining, via the data in the database, that all actions performed by the training command were from one or more allowed data source; and identifying, if any, data leakage while training the machine learning model.

Clause 21. The system of clause 17 or any previous clause, wherein the implicit dependency tracking tool operates at an operating system level for local accesses.

Clause 22. The system of clause 17 or any previous clause, wherein the implicit dependency tracking tool acts as an HTTP proxy for remote data accesses to intercept network communications performed by the training command.

Clause 23. A computer-readable storage device storing instructions which, when executed by one or more processor, cause the one or more processor to be configured to: observe, when training a machine learning model and via a software tool, actions associated with data used to train the machine learning model, wherein the actions are performed by a training command run to train the machine learning model; generate a database comprising the data; and determine, based on the data, machine learning model provenance without altering source code associated with executing components of the machine learning model.

Clause 24. The computer-readable storage device of clause 23, wherein the data comprises one or more of file read information, source bucket information, directory information or output file information.

Clause 25. The computer-readable storage device of clause 24 or any previous clause, wherein the file read information comprises one or more of a file name, a file identifier, a file version, a date associated with a creation of a file, and a date associated with a most recent change to a file.

Clause 26. The computer-readable storage device of clause 24 or any previous clause, wherein the source bucket information comprises one or more of a path, a git repo identifier and commit version, a source computing device, input information, output information, and a database identification.

Clause 27. The computer-readable storage device of clause 24 or any previous clause, wherein directory information comprises one or more of a path, a git repo identifier and commit version, a source computing device, input information, output information, a directory identification and a database identification.

Clause 28. The computer-readable storage device of clause 23 or any previous clause, wherein the software tool comprises an implicit dependency tracking tool that observes the actions performed by a training command used to train the machine learning model.

Clause 29. The computer-readable storage device of clause 28 or any previous clause, wherein the actions comprise one or more of reading a file, performing a git repo done on a project code, obtaining a version of the project code, accessing a cloud-stored object having a date and version, and generating an output file.

Clause 30. The computer-readable storage device of clause 29 or any previous clause, wherein the data comprises information about all the actions taken by the implicit dependency tracking tool.

Clause 31. The computer-readable storage device of clause 23 or any previous clause, wherein the instructions, when executed by the one or more processor, further cause the one or more processor to be configured to determine, based on the data, the machine learning model provenance by: determining, via the data in the database, that all actions performed by the training command were from one or more allowed data source; and identifying, if any, data leakage while training the machine learning model.

Clause 32. The computer-readable storage device of clause 28 or any previous clause, wherein the implicit dependency tracking tool operates at an operating system level for local accesses.

Clause 33. The computer-readable storage device of clause 28 or any previous clause, wherein the implicit dependency tracking tool acts as an HTTP proxy for remote data accesses to intercept network communications performed by the training command.

Clause 34. A software tool for use in connection with implementing operations associated with a companion command, wherein the software tool, when implemented, causes one or more processor to be configured to: observe, when training a machine learning model, actions associated with data used to train the machine learning model, wherein the actions are performed by a training command run to train the machine learning model; generate a database comprising the data; and determine, based on the data, machine learning model provenance without altering source code associated with executing components of the machine learning model.

Clause 35. The software tool of clause 34, wherein the software tool, when executed by the one or more processor, further cause the one or more processor to be configured to determine, based on the data, the machine learning model provenance by: determining, via the data in the database, that all actions performed by the training command were from one or more allowed data source; and identifying, if any, data leakage while training the machine learning model.

Clause 36. The software tool of clause 34 or any previous clause, wherein the software tool is implemented by one of a user interaction with a graphical object or a user input via a command-line interface.

Clause 37. A method comprising: observing, when operating a machine learning model and via a software tool, actions associated with data used to use the machine learning model, wherein the actions are performed by a command run to use the machine learning model; generating a database comprising the data; and determining, based on the data, machine learning model provenance without altering source code associated with executing components of the machine learning model.

Clause 38. A system comprising: one or more processor; and a computer-readable storage device storing instructions which, when executed by the one or more processor, cause the one or more processor to be configured to: observe, when operating a machine learning model and via a software tool, actions associated with data used to use the machine learning model, wherein the actions are performed by a command run to use the machine learning model; generate a database comprising the data; and determine, based on the data, machine learning model provenance without altering source code associated with executing components of the machine learning model.

Clause 39. A computer-readable storage device storing instructions which, when executed by one or more processor, cause the one or more processor to be configured to: observe, when operating a machine learning model and via a software tool, actions associated with data used to use the machine learning model, wherein the actions are performed by a command run to use the machine learning model; generate a database comprising the data; and determine, based on the data, machine learning model provenance without altering source code associated with executing components of the machine learning model.

Clause 40. A software tool configured to: observe, when operating a machine learning model, actions associated with data used to use the machine learning model, wherein the actions are performed by a command run to use the machine learning model; generate a database comprising the data; and determine, based on the data, machine learning model provenance without altering source code associated with executing components of the machine learning model.

We claim:

1. A method comprising:
observing, when training a machine learning model and via a software tool, actions associated with data used to train the machine learning model, wherein the actions are performed by a training command run to train the machine learning model;
generating a database comprising the data; and
determining, based on the data, machine learning model provenance without altering source code associated with executing components of the machine learning model.

2. The method of claim 1, wherein the data comprises one or more of file read information, source bucket information, directory information or output file information.

3. The method of claim 2, wherein the file read information comprises one or more of a file name, a file identifier, a file version, a date associated with a creation of a file, and a date associated with a most recent change to a file.

4. The method of claim 2, wherein the source bucket information comprises one or more of a path, a git repo identifier and commit version, a source computing device, input information, output information, and a database identification.

5. The method of claim 2, wherein directory information comprises one or more of a path, a git repo identifier and commit version, a source computing device, input information, output information, a directory identification and a database identification.

6. The method of claim 1, wherein the software tool comprises an implicit dependency tracking tool that observes the actions performed by a training command used to train the machine learning model.

7. The method of claim 6, wherein the actions comprise one or more of reading a file, performing a git repo done on a project code, obtaining a version of the project code, accessing a cloud-stored object having a date and version, and generating an output file.

8. The method of claim 7, wherein the data comprises information about all the actions taken by the implicit dependency tracking tool.

9. The method of claim 1, wherein determining, based on the data, the machine learning model provenance further comprises:
determining, via the data in the database, that all actions performed by the training command were from one or more allowed data source; and
identifying, if any, data leakage while training the machine learning model.

10. The method of claim 6, wherein the implicit dependency tracking tool operates at an operating system level for local accesses.

11. The method of claim 6, wherein the implicit dependency tracking tool acts as an HTTP proxy for remote data accesses to intercept network communications performed by the training command.

12. A system comprising:
one or more processor; and
a computer-readable storage device storing instructions which, when executed by the one or more processor, cause the one or more processor to be configured to:
observe, when training a machine learning model and via a software tool, actions associated with data used to train the machine learning model, wherein the actions are performed by a training command run to train the machine learning model;
generate a database comprising the data; and
determine, based on the data, machine learning model provenance without altering source code associated with executing components of the machine learning model.

13. The system of claim 12, wherein the data comprises one or more of file read information, source bucket information, directory information or output file information.

14. The system of claim 13, wherein the file read information comprises one or more of a file name, a file identifier, a file version, a date associated with a creation of a file, and a date associated with a most recent change to a file.

15. The system of claim 13, wherein the source bucket information comprises one or more of a path, a git repo identifier and commit version, a source computing device, input information, output information, and a database identification.

16. The system of claim 13, wherein directory information comprises one or more of a path, a git repo identifier and commit version, a source computing device, input information, output information, a directory identification and a database identification.

17. The system of claim 12, wherein the software tool comprises an implicit dependency tracking tool that observes the actions performed by a training command used to train the machine learning model.

18. The system of claim 17, wherein the actions comprise one or more of reading a file, performing a git repo done on a project code, obtaining a version of the project code, accessing a cloud-stored object having a date and version, and generating an output file.

19. The system of claim 18, wherein the data comprises information about all the actions taken by the implicit dependency tracking tool.

20. A software tool for use in connection with implementing operations associated with a companion command, wherein the software tool, when implemented, causes one or more processor to be configured to:
observe, when training a machine learning model, actions associated with data used to train the machine learning model, wherein the actions are performed by a training command run to train the machine learning model;
generate a database comprising the data; and
determine, based on the data, machine learning model provenance without altering source code associated with executing components of the machine learning model.
